(19) United States
(12) Patent Application Publication
(10) Pub. No.: US 2026/0095800 A1
(43) Pub. Date: Apr. 2, 2026

(54) METHOD AND APPARATUS FOR SUPPORTING MOBILITY OF TERMINAL

(71) Applicant: Electronics and Telecommunications Research Institute, Daejeon (KR)

(72) Inventors: Hyung Deug BAE, Daejeon (KR); Sook Yang KANG, Daejeon (KR); Joohan PARK, Daejeon (KR); Myungsan BAE, Daejeon (KR); Jaesheung SHIN, Daejeon (KR); Jae Wook SHIN, Daejeon (KR); Chahyeon EOM, Daejeon (KR); Sung-Min OH, Daejeon (KR); Kwang Ryul JUNG, Daejeon (KR); You Sun HWANG, Daejeon (KR)

(21) Appl. No.: 19/342,296

(22) Filed: Sep. 26, 2025

(30) Foreign Application Priority Data
Sep. 30, 2024 (KR) 10-2024-0132586
Aug. 26, 2025 (KR) 10-2025-0119484

(51) Int. Cl. H04W 24/10; H04W 36/08; H04W 36/30; H04W 64/00; H04W 72/563; H04W 84/06

(52) U.S. Cl. CPC H04W 24/10; H04W 36/08; H04W 36/302; H04W 64/00; H04W 72/563; H04W 84/06

(57) ABSTRACT

A method of a terminal may comprise: receiving, from a satellite, cell information of a terrestrial network operator with which the terminal is registered; determining whether the terminal exists within a cell of the terrestrial network operator based on the cell information; and measuring the cell of the terrestrial network operator based on that the terminal exists within the cell of the terrestrial network operator.

### CROSS-REFERENCE TO RELATED APPLICATIONS

This application claims priority to Korean Patent Applications No. 10-2024-0132586, filed on Sep. 30, 2024, and No. 10-2025-0119484, filed on Aug. 26, 2025, with the Korean Intellectual Property Office (KIPO), the entire contents of which are hereby incorporated by reference.

### BACKGROUND

### 1. Technical Field

The present disclosure relates to a technique for supporting mobility of a terminal, and more particularly, to a method and an apparatus for supporting mobility of a terminal between a non-terrestrial network (NTN) and a terrestrial network (TN).

### 2. Related Art

A communication network may be classified into a terrestrial network and a non-terrestrial network. The non-terrestrial network may be referred to as an NTN. In the terrestrial network, a communication service for a terminal may be provided by a base station located on the ground. In the non-terrestrial network, a communication service for a terminal may be provided by a base station located in a non-terrestrial device (e.g. satellite, unmanned aerial vehicle (UAV), drone, etc.). Communication in the terrestrial network and the non-terrestrial network may be performed based on New Radio (NR) communication technology.

In a satellite-based non-terrestrial network, a satellite may configure on the ground one or more non-terrestrial network cells, for example, satellite cells. The non-terrestrial network cell may have a relatively large size compared with a terrestrial network cell. Accordingly, the non-terrestrial network cell may overlap with one or more terrestrial network cells. Each of the non-terrestrial network cell and the one or more terrestrial network cells may operate in different frequencies.

When a mobility condition is satisfied, a terminal connected to the non-terrestrial network cell may move from the non-terrestrial network cell to a terrestrial network cell through reselection or handover to the terrestrial network cell. The terminal may receive information on terrestrial network cells from the satellite. The terminal may perform measurement for cell search on the terrestrial network cells based on the received information. The terminal may perform reselection of a terrestrial network cell or may perform handover to a terrestrial network cell based on a measurement result.

A terrestrial network cell may include a cell coverage of each of a plurality of network operators. The terminal may be registered with one operator among the plurality of network operators. Here, when the terminal is located in coverage of an operator with which the terminal is not registered, the terminal may perform unnecessary measurement for cell search on terrestrial network cells, and thus power consumption of the terminal may increase.

### SUMMARY

The present disclosure for resolving the above-described problems is directed to providing a method and an apparatus for supporting mobility of a terminal, which enable the terminal to determine measurement for detecting a TN cell based on a location of the terminal.

According to a first exemplary embodiment of the present disclosure, a method of a terminal may comprise: receiving, from a satellite, cell information of a terrestrial network operator with which the terminal is registered; determining whether the terminal exists within a cell of the terrestrial network operator based on the cell information; and measuring the cell of the terrestrial network operator based on that the terminal exists within the cell of the terrestrial network operator.

The cell information may include cell coverage information of the terrestrial network operator, and the determining of whether the terminal exists within the cell of the terrestrial network operator may comprise: acquiring a current location of the terminal; and determining whether the current location of the terminal is included in the cell of the terrestrial network operator based on a reference location and a radius distance of the cell coverage information.

The cell information may include cell frequency information of the terrestrial network operator, and the measuring of the cell of the terrestrial network operator may comprise: measuring the cell of the terrestrial network operator based on the cell frequency information.

The method may further comprise: periodically repeating an operation of determining whether the terminal exists within the cell of the terrestrial network operator based on that the terminal does not exist within the cell of the terrestrial network operator.

The method may further comprise: determining whether a cell reselection condition is satisfied based on a measurement result for the cell of the terrestrial network operator; and camping on the cell of the terrestrial network operator based on that the cell reselection condition is satisfied.

The determining of whether the cell reselection condition is satisfied may comprise: measuring a signal reception strength of each of a non-terrestrial network cell and the cell of the terrestrial network operator; and determining satisfaction of the cell reselection condition based on that the signal reception strength of the cell of the terrestrial network operator is greater than the signal reception strength of the non-terrestrial network cell.

The determining of whether the cell reselection condition is satisfied may comprise: comparing frequency priorities of the non-terrestrial network cell and the cell of the terrestrial network operator; and determining satisfaction of the cell reselection condition based on that the frequency priority of the cell of the terrestrial network operator is higher than the frequency priority of the non-terrestrial network cell.

The method may further comprise: receiving, from the satellite, a measurement configuration message; reporting, to the satellite, a measurement result for the cell of the terrestrial network operator based on the measurement configuration message; receiving, from the satellite, a handover instruction determined based on the measurement result; and performing a handover from the satellite to a base station of the terrestrial network operator based on the handover instruction.

The method may further comprise: measuring a cell of another terrestrial network operator overlapping with the cell of the terrestrial network operator based on the measurement configuration message; reporting, to the satellite, measurement results for the cell of the terrestrial network operator and the cell of another terrestrial network operator; determining whether a handover condition is satisfied based on the handover instruction received from the satellite; and performing a handover from the satellite to a base station of one of the terrestrial network operator and the another terrestrial network operator based on satisfaction of the handover condition and based on the handover instruction.

The determining of whether the handover condition is satisfied may comprise: measuring a signal reception strength of each of the cell of the terrestrial network operator and the cell of another terrestrial network operator cell; and determining satisfaction of the handover condition based on that the signal reception strength of the cell of the terrestrial network operator is greater than the signal reception strength of the another terrestrial network operator cell.

According to a second exemplary embodiment of the present disclosure, a terminal may comprise at least one processor, and the at least one processor may cause the terminal to perform: receiving, from a satellite, cell information of a terrestrial network operator with which the terminal is registered; determining whether the terminal exists within a cell of the terrestrial network operator based on the cell information; and measuring the cell of the terrestrial network operator based on that the terminal exists within the cell of the terrestrial network operator.

The cell information may include cell coverage information of the terrestrial network operator, and in the determining of whether the terminal exists within the cell of the terrestrial network operator, the at least one processor may cause the terminal to perform: acquiring a current location of the terminal; and determining whether the current location of the terminal is included in the cell of the terrestrial network operator based on a reference location and a radius distance of the cell coverage information.

The cell information may include cell frequency information of the terrestrial network operator, and in the measuring of the cell of the terrestrial network operator, the at least one processor may cause the terminal to perform: measuring the cell of the terrestrial network operator based on the cell frequency information.

The at least one processor may further cause the terminal to perform: periodically repeating an operation of determining whether the terminal exists within the cell of the terrestrial network operator based on that the terminal does not exist within the cell of the terrestrial network operator.

The at least one processor may further cause the terminal to perform: determining whether a cell reselection condition is satisfied based on a measurement result for the cell of the terrestrial network operator; and camping on the cell of the terrestrial network operator based on that the cell reselection condition is satisfied.

In the determining of whether the cell reselection condition is satisfied, the at least one processor may cause the terminal to perform: measuring a signal reception strength of each of a non-terrestrial network cell and the cell of the terrestrial network operator; and determining satisfaction of the cell reselection condition based on that the signal reception strength of the cell of the terrestrial network operator is greater than the signal reception strength of the non-terrestrial network cell.

In the determining of whether the cell reselection condition is satisfied, the at least one processor may cause the terminal to perform: measuring a signal reception strength of each of a non-terrestrial network cell and the cell of the terrestrial network operator; and determining satisfaction of the cell reselection condition based on that the signal reception strength of the cell of the terrestrial network operator is greater than the signal reception strength of the non-terrestrial network cell.

The at least one processor may further cause the terminal to perform: receiving, from the satellite, a measurement configuration message; reporting, to the satellite, a measurement result for the cell of the terrestrial network operator based on the measurement configuration message; receiving, from the satellite, a handover instruction determined based on the measurement result; and performing a handover from the satellite to a base station of the terrestrial network operator based on the handover instruction.

The at least one processor may further cause the terminal to perform: measuring a cell of another terrestrial network operator overlapping with the cell of the terrestrial network operator based on the measurement configuration message; reporting, to the satellite, measurement results for the cell of the terrestrial network operator and the cell of another terrestrial network operator; determining whether a handover condition is satisfied based on the handover instruction received from the satellite; and performing a handover from the satellite to a base station of one of the terrestrial network operator and the another terrestrial network operator based on satisfaction of the handover condition and based on the handover instruction.

In the determining of whether the handover condition is satisfied, the at least one processor may cause the terminal to perform: measuring a signal reception strength of each of the cell of the terrestrial network operator and the cell of another terrestrial network operator cell; and determining satisfaction of the handover condition based on that the signal reception strength of the cell of the terrestrial network operator is greater than the signal reception strength of the another terrestrial network operator cell.

According to the present disclosure, when the terminal exists within a cell coverage of a registered TN operator among coverages of a plurality of TN operators of TN cells overlapping with an NTN cell, the terminal can perform cell measurement based on a frequency of a corresponding cell. Accordingly, the terminal can omit unnecessary measurement for cells of other TN operators and can prevent an increase in power consumption. Furthermore, the terminal can perform cell reselection or handover from the NTN cell to a TN cell based on a measurement result and can improve efficiency of terminal mobility support.

### BRIEF DESCRIPTION OF DRAWINGS

FIG. 1 is a diagram illustrating an exemplary embodiment of a non-terrestrial network.

FIG. 2 is a diagram illustrating an exemplary embodiment of a non-terrestrial network.

FIG. 3 is a block diagram illustrating an exemplary embodiment of a communication node constituting a non-terrestrial network.

FIG. 4 is a conceptual diagram illustrating an exemplary embodiment of a cell layout of a non-terrestrial network and a terrestrial network.

FIG. 5 is a conceptual diagram illustrating an exemplary embodiment of cell coverages of a plurality of terrestrial network operators.

FIG. 6 is a flowchart illustrating a first exemplary embodiment of a method of measurement for TN cells by a terminal.

FIG. 7 is a flowchart illustrating a second exemplary embodiment of a method of measurement for TN cells by a terminal.

FIG. 8 is a flowchart illustrating an exemplary embodiment of a method of cell reselection of a terminal.

FIG. 9 is a sequence chart illustrating an exemplary embodiment of a handover method of a terminal.

FIG. 10 is a sequence chart illustrating an exemplary embodiment of a conditional handover method of a terminal.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In exemplary embodiments of the present disclosure, “(re) transmission” may mean “transmission”, “retransmission”, or “transmission and retransmission”, “(re) configuration” may mean “configuration”, “reconfiguration”, or “configuration and reconfiguration”, “(re) connection” may mean “connection”, “reconnection”, or “connection and reconnection”, and “(re) access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e. “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication network to which exemplary embodiments according to the present disclosure are applied will be described. The communication network may be a non-terrestrial network (NTN), a 4G communication network (e.g. Long-Term Evolution (LTE) communication network), a 5G communication network (e.g. New Radio (NR) communication network), or a B5G mobile communication network (e.g. 6G mobile communication network). The 4G communication network and the 5G communication network may be classified as terrestrial networks.

In exemplary embodiments, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. The signaling may be at least one of system information (SI) signaling (e.g. transmission of system information block (SIB) and/or master information block (MIB)), RRC signaling (e.g. transmission of RRC parameters and/or higher layer parameters), MAC control element (CE) signaling, or PHY signaling (e.g. transmission of downlink control information (DCI), uplink control information (UCI), and/or sidelink control information (SCI)).

In the present disclosure, even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a terminal is described, a base station corresponding to the terminal may perform an operation corresponding to the operation of the terminal. Conversely, when an operation of a base station is described, a terminal corresponding to the base station may perform an operation corresponding to the operation of the base station. In addition, when an operation of a first terminal is described, a second terminal corresponding to the first terminal may perform an operation corresponding to the operation of the first terminal. Conversely, when an operation of a second terminal is described, a first terminal corresponding to the second terminal may perform an operation corresponding to the operation of the second terminal.

In the present disclosure, a phrase including “when ˜” may be expressed as a phrase including “based on ˜” or as a phrase including “in response to ˜”. In other words, a phrase including “when ˜” may be interpreted as being the same as or similar to a phrase including “based on ˜” or a phrase including “in response to ˜”.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

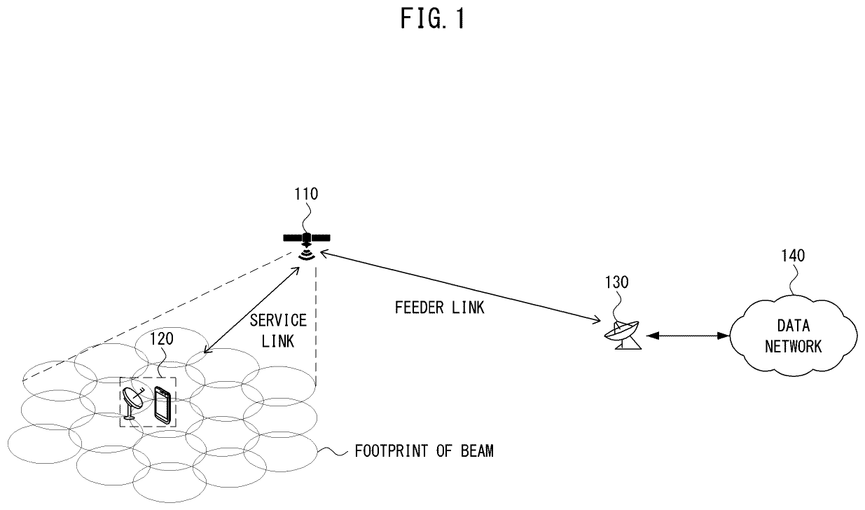

FIG. 1 is a diagram illustrating an exemplary embodiment of a non-terrestrial network.

Referring to FIG. 1, a non-terrestrial network 100 of the present exemplary embodiment may be a communication network based on at least one satellite 110. The non-terrestrial network 100 may include the satellite 110, a communication node 120, a gateway 130, and a data network 140. The non-terrestrial network 100 of FIG. 1 may be a non-terrestrial network based on a transparent payload.

The satellite 110 may operate as a non-terrestrial base station in the non-terrestrial network. The satellite 110 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS).

The communication node 120 may include communication nodes located on the ground and communication nodes located in a non-terrestrial space. The communication node located on the ground may be a user equipment (UE) or a terminal. The communication node located in the non-terrestrial space may be an airplane or a drone.

A service link may be established between the satellite 110 and the communication node 120. The service link may be a radio link. The satellite 110 may provide communication services to the communication node 120 by using one or more beams. A footprint of a beam of the satellite 110 may be elliptical. One of the beam footprints of the satellite 110 may have a range of 500 to 1,000 km, and a plurality of communication nodes 120 may be located in one beam footprint.

The communication node 120 may perform downlink communication or uplink communication with the satellite 110 using LTE technology and/or NR technology. The communications between the satellite 110 and the communication node 120 may be performed using an NR-Uu interface. When dual connectivity (DC) is supported, the communication node 120 may be connected to other base stations supporting LTE and/or NR functionality as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI). The gateway 130 may be connected to the data network 140.

There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network may be performed based on an NG-C/U interface.

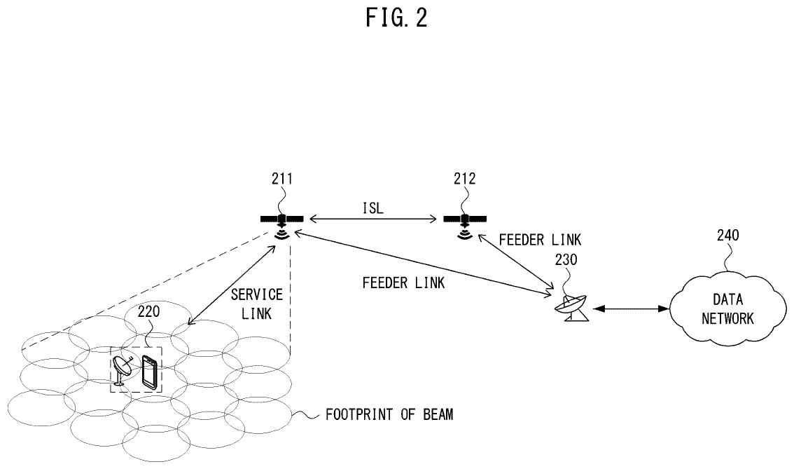

FIG. 2 is a diagram illustrating an exemplary embodiment of a non-terrestrial network.

Referring to FIG. 2, a non-terrestrial network 200 of the present exemplary embodiment may be a communication network based on a plurality of satellites 211 and 212. The non-terrestrial network 200 may include a first satellite 211, a second satellite 212, a communication node 220, a gateway 230, and a data network 240.

The non-terrestrial network 200 shown in FIG. 2 may be a regenerative payload based NTN. For example, each of the first satellite 211 and the second satellite 212 may perform a regenerative operation on a payload received from other entities (e.g. the communication node 220 or the gateway 230), and transmit the regenerated payload. Here, the regenerative operation may include demodulation, decoding, re-encoding, re-modulation, and/or filtering operations.

Each of the first satellite 211 and the second satellite 212 may be a LEO satellite, a MEO satellite, a GEO satellite, a HEO satellite, or a UAS platform. The UAS platform may include a HAPS. The first satellite 211 may be connected to the second satellite 212, and an inter-satellite link (ISL) may be established between the first satellite 211 and the second satellite 212. The ISL may operate in an RF frequency band or an optical band. The ISL may be established optionally.

The communication node 220 may include a communication node located on the ground and a communication node located in a non-terrestrial space. The communication node located on the ground may be a user equipment (UE) or a terminal. The communication node located in the non-terrestrial space may be an airplane or a drone.

A service link may be established between the first satellite 211 and the communication node 220. The service link may be a radio link. The first satellite 211 may provide communication services to the communication node 220 using one or more beams. A footprint of a beam of the first satellite 211 may be elliptical.

The communication node 220 may perform downlink communication or uplink communication with the first satellite 211 using LTE technology and/or NR technology. The communications between the first satellite 211 and the communication node 220 may be performed using an NR-Uu interface. When DC is supported, the communication node 220 may be connected to other base stations supporting LTE and/or NR functionality as well as the first satellite 211, and may perform DC operations based on the techniques defined in the LTE and/or NR specifications.

The gateway 230 may be located on a terrestrial site, a feeder link may be established between the first satellite 211 and the gateway 230, and a feeder link may be established between the second satellite 212 and the gateway 230. The feeder link may be a radio link. When the ISL is not established between the first satellite 211 and the second satellite 212, the feeder link between the first satellite 211 and the gateway 230 may be established mandatorily. The communications between each of the first satellite 211 and the second satellite 212 and the gateway 230 may be performed based on an NR-Uu interface or an SRI.

There may be a core network between the gateway 230 and the data network 240. In this case, the gateway 230 may be connected to the core network, and the core network may be connected to the data network 240. The core network may support the NR technology. For example, the core network may include AMF, UPF, SMF, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network may be performed based on an NG-C/U interface.

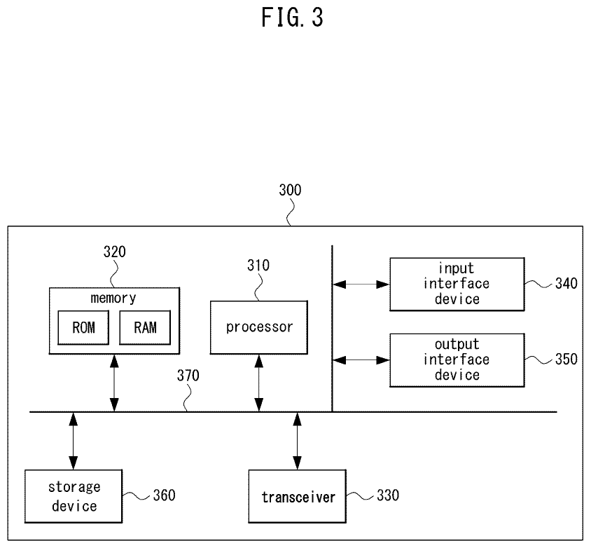

FIG. 3 is a block diagram illustrating an exemplary embodiment of a communication node constituting a non-terrestrial network.

Referring to FIG. 3, a communication node 300 may include at least one processor 310, a memory 320, and a transceiver 330 connected to a network to perform communication. In addition, the communication node 300 may further include an input interface device 340, an output interface device 350, a storage device 360, and the like. The components included in the communication node 300 may be connected by a bus 370 to communicate with each other.

However, each component included in the communication node 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed.

Each of the memory 320 and the storage device 360 may be configured as at least one of a volatile storage medium and a nonvolatile storage medium. For example, the memory 320 may be configured with at least one of a read only memory (ROM) and a random access memory (RAM).

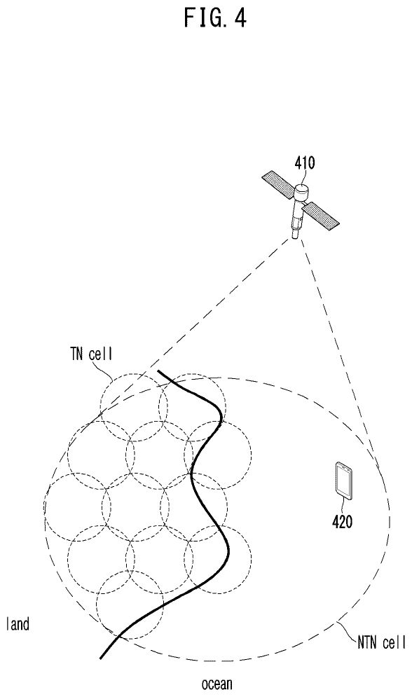

FIG. 4 is a conceptual diagram illustrating an exemplary embodiment of a cell layout of a non-terrestrial network and a terrestrial network.

Referring to FIG. 4, a satellite 410 of a non-terrestrial network may configure one or more non-terrestrial network cells (hereinafter, ‘NTN cells’) on the ground. The NTN cell may have a relatively large size compared to a terrestrial network cell (hereinafter, ‘TN cell’) configured by a base station of a terrestrial network. Accordingly, in a land area on the ground, an NTN cell may be arranged to overlap with one or more TN cells, and in an ocean area on the ground, the NTN cell may be arranged. The NTN cell and the TN cells may operate in different frequency bands.

A terminal 420 may be located in the ocean area and may be connected to a satellite 410 of the non-terrestrial network via the NTN cell. The terminal 420 may be in a radio resource control (RRC) connected state capable of transmitting and receiving data with the satellite, or may be in an RRC idle state or an RRC inactive state capable of receiving a paging message from the satellite 410 by camping on the NTN cell. The terminal 420 may acquire location information by using a device such as a global positioning system (GPS) receiver, and may support location-based measurement for the NTN cell.

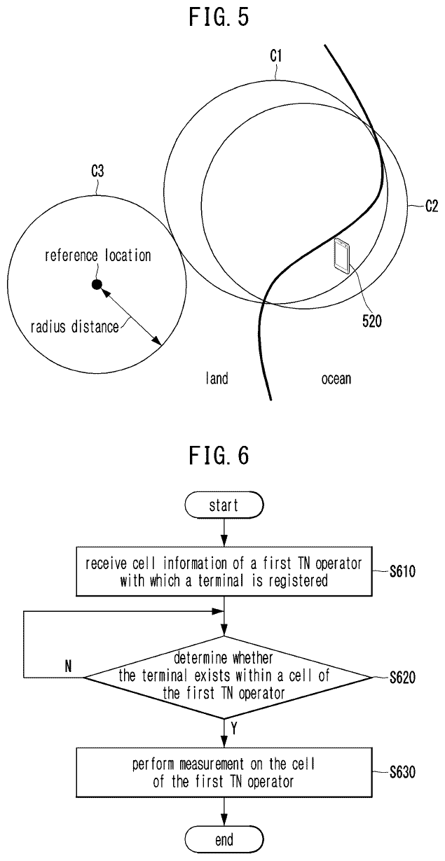

FIG. 5 is a conceptual diagram illustrating an exemplary embodiment of cell coverages of a plurality of terrestrial network operators.

Referring to FIG. 5, TN cells may include cell coverage of each of a plurality of terrestrial network operators (hereinafter, ‘TN operators’). For example, TN cells may include a first cell coverage C1 of a first TN operator, a second cell coverage C2 of a second TN operator, and a third cell coverage C3 of a third TN operator. Each of the first cell coverage C1 to the third cell coverage C3 may be represented by a reference location tn-ReferenceLocation and a radius distance tn-DistanceRadius. The first cell coverage C1 to the third cell coverage C3 may partially overlap. For example, the first cell coverage C1 and the second cell coverage C2 may be arranged to overlap in a similar area. The third cell coverage C3 may be arranged in another area that does not overlap with each of the first cell coverage C1 or the second cell coverage C2. The first cell coverage C1 to the third cell coverage C3 may have different frequency bands.

A terminal 520 may be in a state connected to a satellite of a non-terrestrial network via an NTN cell. The terminal 520 may be located in an overlapping area of the NTN cell and TN cells, for example, an overlapping area of the NTN cell, the first cell coverage C1, and the second cell coverage C2. The terminal 520 may move from the NTN cell to a TN cell based on whether a mobility condition is satisfied. For example, the terminal 520 may receive system information (SI) from the satellite via the NTN cell. The system information may include information on TN cells, for example, at least one of coverage information or frequency information of each of the first cell coverage C1 to the third cell coverage C3. The terminal 520 may perform measurement for TN cell detection, for example, measurement on frequencies of the TN cells, based on the received system information. The terminal 520 may reselect a TN cell based on a measurement result, and may move from the NTN cell to the reselected TN cell. In addition, the terminal 520 may transmit the measurement result to the satellite and may receive a handover instruction from the satellite to perform a handover to a base station of the TN cell.

The terminal 520 may be registered with one of a plurality of TN operators. When the terminal 520 does not exist in a cell coverage of the TN operator with which the terminal 520 is registered, the terminal 520 may perform unnecessary measurement for TN cell detection. For example, the terminal 520 may be in a state registered with the third TN operator and may be connected to the satellite via the NTN cell. The terminal 520 may perform measurement for TN cell detection based on the system information received from the satellite. In this case, the terminal 520 may be located in an overlapping area of cells of other TN operators, for example, the first cell coverage C1 and the second cell coverage C2, not a cell of the third TN operator. Accordingly, the terminal 520 may perform unnecessary measurements on cells of the first TN operator or the second TN operator, not the cell of the third TN operator, based on the received system information, and thus power consumption of the terminal 520 may increase.

FIG. 6 is a flowchart illustrating a first exemplary embodiment of a method of measurement for TN cells by a terminal.

The terminal may be connected to a satellite via an NTN cell and may be in an RRC connected state, an RRC idle state, or an RRC inactive state with the satellite. The NTN cell may overlap with one or more TN cells, and the one or more TN cells may include cells of a plurality of TN operators. The terminal may be in a state registered with one TN operator among the plurality of TN operators, for example, a first TN operator.

Referring to FIG. 6, the satellite may broadcast system information including cell information of the first TN operator with which the terminal is registered to the terminal. In an exemplary embodiment, the satellite may transmit the system information including the cell information of the first TN operator to the terminal through an RRC message. The terminal may receive information on cell(s) of the first TN operator from the satellite (S610).

The cell information of the first TN operator may include at least one of coverage information or frequency information. The coverage information may include at least one of a coverage ID In-AreaId, a reference location in-ReferenceLocation, or a radius distance tn-DistanceRadius. The frequency information may include at least one of frequency priority information cellReselectionPriority, identification information tn-PlmnInfo of the first TN operator, a carrier frequency dl-CarrierFreq, or a coverage ID In-AreaId. The identification information tn-PlmnInfo of the first TN operator may include at least one of a network ID PlmnId of the first TN operator, a network ID equivalent-PlmnId of an equivalent operator, or an ID of the first TN operator.

The terminal may determine whether the terminal exists within a cell of the first TN operator based on the received coverage information of the first TN operator (S620). The terminal may include a GPS receiver and may acquire a current location of the terminal through the GPS receiver. The terminal may determine whether the current location of the terminal is included in the cell coverage of the first TN operator based on the current location of the terminal and the reference location and the radius distance of the coverage information.

When the terminal exists in a cell of the first TN operator (Y), the terminal may measure the cell of the first TN operator based on the frequency information of the first TN operator, for example, a cell frequency of the first TN operator (S630). For example, the terminal may measure a signal transmitted to the cell through at least one of an inter-frequency or an inter-radio access technology (RAT) frequency of the cell of the first TN operator.

When the terminal does not exist in a cell of the first TN operator (N), the terminal may not perform cell measurement. In addition, the terminal may periodically or aperiodically repeat step S620 of determining whether the terminal exists in a cell of the first TN operator.

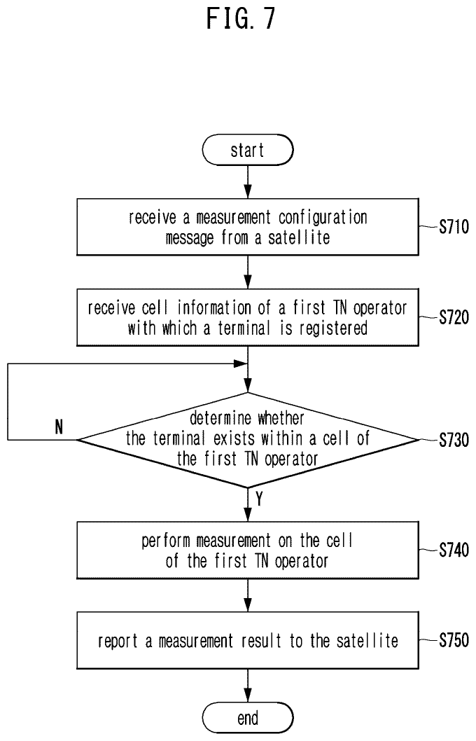

FIG. 7 is a flowchart illustrating a second exemplary embodiment of a method of measurement for TN cells by a terminal.

As described above, a terminal may be connected to a satellite via an NTN cell and may be in an RRC connected state, an RRC idle state, or an RRC inactive state with the satellite. The NTN cell may overlap with one or more TN cells, and the one or more TN cells may include cells of a plurality of TN operators. The terminal may be in a state registered with one TN operator among the plurality of TN operators, for example, a first TN operator.

Referring to FIG. 7, the satellite may transmit a measurement configuration message (e.g. RRCReconfiguration) including measurement configuration information (e.g. measConfig) to the terminal. The terminal may receive the measurement configuration message transmitted from the satellite (S710).

The measurement configuration message may include at least one of cell information for TN cells overlapping with the NTN cell or configuration information (e.g. measReport) for reporting a measurement result. The cell information for TN cells may include at least one of coverage information or frequency information of each of the plurality of TN operators. The coverage information of each TN operator may include at least one of a coverage ID, a reference location, or a radius distance. The frequency information of each TN operator may include at least one of frequency priority information, TN operator identification information, a carrier frequency, or a coverage ID.

The satellite may broadcast system information including cell information of the first TN operator with which the terminal is registered, for example, at least one of coverage information or frequency information of the first TN operator, to the terminal. In an exemplary embodiment, the satellite may transmit the system information including the cell information of the first TN operator to the terminal through an RRC message. The terminal may receive the cell information of the first TN operator from the satellite (S720).

The coverage information of the first TN operator may include at least one of a coverage ID, a reference location, or a radius distance. The frequency information of the first TN operator may include at least one of frequency priority information, first TN operator identification information, a carrier frequency, or a coverage ID. In an exemplary embodiment, when the satellite has transmitted the measurement configuration message including coverage information or frequency information of each of the plurality of TN operators to the terminal, the satellite may omit the operation of transmitting the cell information of the first TN operator to the terminal.

The terminal may determine whether the terminal exists in a cell of the first TN operator based on the received coverage information of the first TN operator (S730). The terminal may include a GPS receiver and may acquire a current location of the terminal through the GPS receiver. The terminal may determine whether the current location of the terminal is included in the cell coverage of the first TN operator based on the current location of the terminal and the reference location and the radius distance of the coverage information.

When the terminal exists in a cell of the first TN operator (Y), the terminal may measure the cell of the first TN operator based on the frequency information of the first TN operator (740). For example, the terminal may measure a signal transmitted through at least one of an inter-frequency or an inter-RAT frequency for the cell of the first TN operator. The terminal may report a measurement result for the cell of the first TN operator to the satellite (750).

When the terminal does not exist in a cell of the first TN operator (N), the terminal may not perform cell measurement. The terminal may periodically or aperiodically repeat step S730 of determining whether the terminal exists in a cell of the first TN operator.

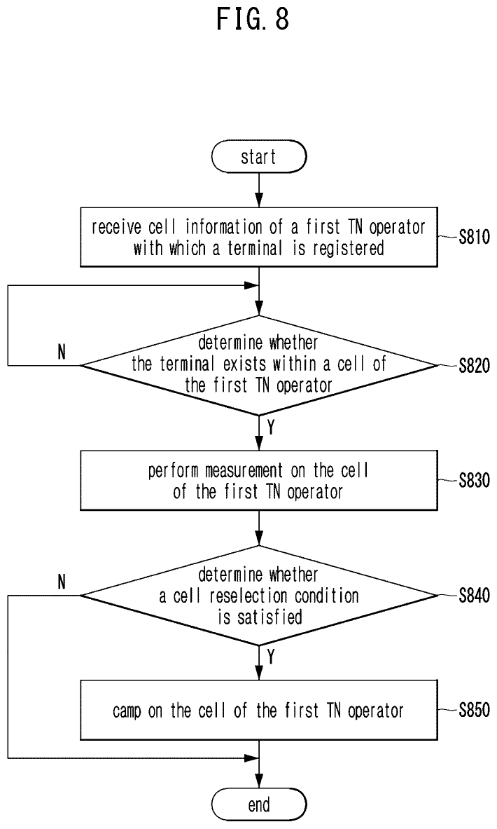

FIG. 8 is a flowchart illustrating an exemplary embodiment of a method of cell reselection of a terminal.

A terminal may be connected to a satellite via an NTN cell and may be in an RRC idle state or an RRC inactive state with the satellite. The NTN cell may overlap with one or more TN cells, and the one or more TN cells may include cells of a plurality of TN operators. The terminal may be in a state registered with one TN operator among the plurality of TN operators, for example, a first TN operator.

Referring to FIG. 8, the satellite may broadcast system information including cell information of the first TN operator with which the terminal is registered to the terminal. In an exemplary embodiment, the satellite may transmit the system information including the cell information of the first TN operator to the terminal through an RRC message. The terminal may receive information on cells of the first TN operator from the satellite (S810).

The satellite may broadcast system information including cell information of the first TN operator with which the terminal is registered, for example, at least one of coverage information or frequency information of the first TN operator, to the terminal. In an exemplary embodiment, the satellite may transmit the system information including the cell information of the first TN operator to the terminal through an RRC message. The terminal may receive the cell information of the first TN operator from the satellite (S820).

The coverage information of the first TN operator may include at least one of a coverage ID, a reference location, or a radius distance. The frequency information of the first TN operator may include at least one of frequency priority information, first TN operator identification information, a carrier frequency, or a coverage ID.

The terminal may determine whether the terminal exists in a cell of the first TN operator based on the received coverage information of the first TN operator (S820). The terminal may include a GPS receiver and may acquire a current location of the terminal through the GPS receiver. The terminal may determine whether the current location of the terminal is included in the cell coverage of the first TN operator based on the current location of the terminal and the reference location and the radius distance of the coverage information.

When the terminal exists in a cell of the first TN operator (Y), the terminal may measure the cell of the first TN operator based on the frequency information of the first TN operator (S830). For example, the terminal may measure a signal transmitted through at least one of an inter-frequency or an inter-RAT frequency for the cell of the first TN operator.

When the terminal does not exist in a cell of the first TN operator (N), the terminal may not perform cell measurement. The terminal may periodically or aperiodically repeat step S820 of determining whether the terminal exists in a cell of the first TN operator.

The terminal may determine whether a cell reselection condition is satisfied based on the measurement result for the cell of the first TN operator (S840). The terminal may determine whether the cell reselection condition is satisfied based on at least one of signal reception strength between the NTN cell and the cell of the first TN operator, for example, reference signal received power (RSRP), reference signal received quality (RSRQ), or received signal strength indication (RSSI) of each of the NTN cell and the cell of the first TN operator. In addition, the terminal may determine whether the cell reselection condition is satisfied based on the frequency priority information among the frequency information of the first TN operator. For example, the terminal may compare a frequency band priority of the NTN cell and a frequency band priority of the cell of the first TN operator, and may determine whether the cell reselection condition is satisfied based on a comparison result.

When the cell reselection condition of the terminal is satisfied, the terminal may camp on the cell of the first TN operator from the NTN cell and may wait for reception of a paging message from a base station of the cell of the first TN operator (S850). For example, a case in which the cell reselection condition of the terminal is satisfied may correspond to a case in which the signal reception strength of the cell of the first TN operator is relatively greater than the NTN cell, or a case in which the frequency band priority of the cell of the first TN operator is relatively higher than the frequency band priority of the NTN cell.

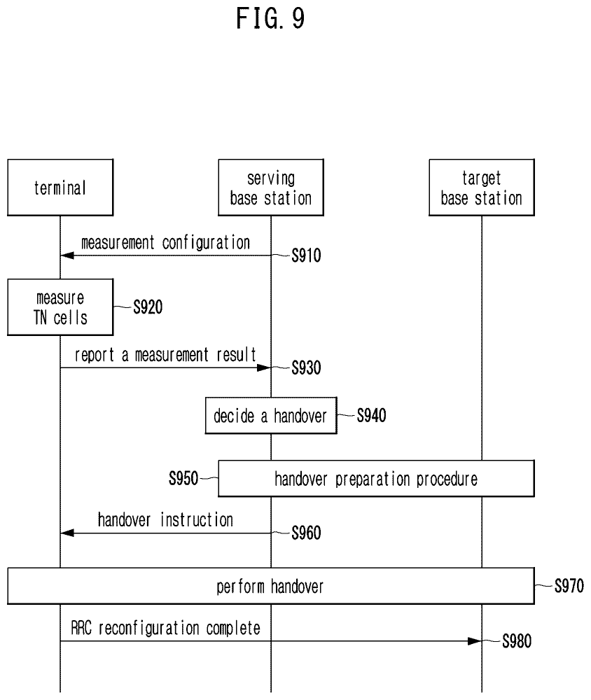

FIG. 9 is a sequence chart illustrating an exemplary embodiment of a handover method of a terminal.

A terminal may be connected to a satellite via an NTN cell and may be in an RRC connected state with the satellite. The NTN cell may overlap with one or more TN cells, and the one or more TN cells may include cells of a plurality of TN operators. The terminal may be in a state registered with one operator among the plurality of TN operators, for example, a first TN operator. A serving base station illustrated in FIG. 9 may be a non-terrestrial base station for the NTN cell, for example, the satellite. A target base station may be a terrestrial base station for cell coverage of the first TN operator.

Referring to FIG. 9, the serving base station may transmit to the terminal a measurement configuration message (RR (′Reconfiguration) including measurement configuration information (measConfig). The terminal may receive the measurement configuration message transmitted from the serving base station (S910).

The measurement configuration message may include cell information for TN cells overlapping with the NTN cell. The cell information for TN cells may include at least one of coverage information or frequency information of each of the plurality of TN operators. The coverage information of each TN operator may include at least one of a coverage ID, a reference location, or a radius distance. The frequency information of each TN operator may include at least one of frequency priority information, TN operator identification information, a carrier frequency, or a coverage ID.

The terminal may measure frequencies of the TN cells based on the received measurement configuration message (S920). For example, the terminal may acquire a current location of the terminal and may determine whether the current location of the terminal is included in cell coverage of the first TN operator based on the coverage information of the first TN operator included in the previously received measurement configuration message. When the terminal exists in a cell of the first TN operator, the terminal may measure the cell of the first TN operator based on the frequency information of the first TN operator. The terminal may report to the serving base station a measurement result for the cell of the first TN operator (S930).

In addition, when the terminal does not exist in a cell of the first TN operator, the terminal may not perform cell measurement. The terminal may periodically or aperiodically repeat the operation of determining whether the terminal exists within the cell coverage of the first TN operator described above.

In an exemplary embodiment, the serving base station may also transmit to the terminal system information including the cell information of the first TN operator with which the terminal is registered, for example, at least one of the coverage information or frequency information of the first TN operator. The terminal may determine whether the terminal exists within a cell coverage of the first TN operator based on the received system information, and may measure a frequency for the cell of the first TN operator according to a determination result.

The serving base station may determine a handover of the terminal based on the measurement result received from the terminal (S940). The serving base station may determine the handover of the terminal and may perform a handover preparation procedure with a target base station as a handover target (S950). For example, the serving base station may request the handover of the terminal to the target base station. The target base station may approve the received handover request and may provide a request approval result as feedback to the serving base station.

The serving base station may transmit a handover instruction to the terminal based on the handover request approval received from the target base station (S960). The serving base station may transmit to the terminal the handover instruction including a handover command. The serving base station may transmit the handover instruction to the terminal through an RRC reconfiguration message.

The terminal may perform a handover from the serving base station to the target base station based on the received handover instruction (S970). The terminal may release the connection with the serving base station and may perform a synchronization procedure and a random access (RA) procedure with the target base station. The terminal may complete the handover through random access with the target base station. The terminal may transmit to the target base station an RRC reconfiguration complete message (S980).

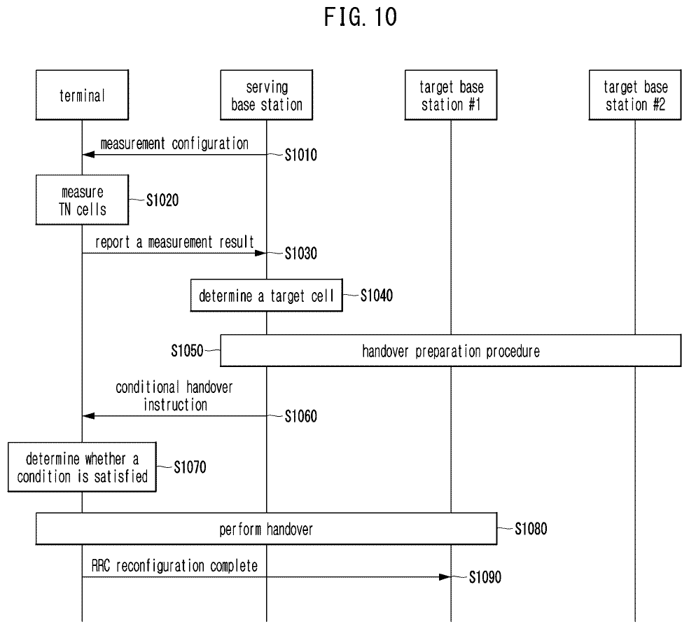

FIG. 10 is a sequence chart illustrating an exemplary embodiment of a conditional handover method of a terminal.

A terminal may be connected to a satellite via an NTN cell and may be in an RRC connected state with the satellite. The NTN cell may overlap with one or more TN cells, and the one or more TN cells may include cells of a plurality of TN operators. The terminal may be in a state registered with one operator among the plurality of TN operators, for example, a first TN operator. A serving base station illustrated in FIG. 10 may be a non-terrestrial base station for the NTN cell, for example, the satellite. A first target base station may be a terrestrial base station for cell coverage of the first TN operator, and a second target base station may be a terrestrial base station for cell coverage of a second TN operator overlapping with the cell coverage of the first TN operator.

Referring to FIG. 10, the serving base station may transmit to the terminal a measurement configuration message including measurement configuration information, for example, an RRC reconfiguration message. The terminal may receive the measurement configuration message transmitted from the serving base station (S1010).

The measurement configuration message may include cell information for TN cells overlapping with the NTN cell. The cell information for TN cells may include at least one of coverage information or frequency information of each of the first TN operator and the second TN operator. The coverage information of each TN operator may include at least one of a coverage ID, a reference location, or a radius distance. The frequency information of each TN operator may include at least one of frequency priority information, TN operator identification information, a carrier frequency, or a coverage ID.

The terminal may measure a frequency for at least one of a cell of the first TN operator or a cell of the second TN operator based on the received measurement configuration message (S1020). For example, the terminal may acquire a current location of the terminal and may determine whether the current location of the terminal is included in cell coverage of the first TN operator based on the previously received coverage information of the first TN operator. When the terminal exists within a cell coverage of the first TN operator, the terminal may measure the cell of the first TN operator based on the frequency information of the first TN operator. In addition, the terminal may determine whether the terminal exists within a cell coverage of the second TN operator based on the coverage information of the second TN operator. When the terminal exists within a cell coverage of the second TN operator, the terminal may measure the cell of the second TN operator based on the frequency information of the second TN operator. The terminal may report to the serving base station measurement results for the cells of the first TN operator and the second TN operator (S1030).

The serving base station may determine a handover of the terminal based on the measurement results received from the terminal. The serving base station may determine, based on the handover determination, at least one of the first target base station or the second target base station as a candidate target base station (S1040). The serving base station may perform a handover preparation procedure with the first target base station or the second target base station (S1050). For example, the serving base station may request the handover of the terminal to the first target base station. The first target base station may approve the received handover request and may provide a request approval result as feedback to the serving base station. In addition, the serving base station may request the handover of the terminal to the second target base station. The second target base station may approve the received handover request and may provide a request approval result as feedback to the serving base station.

The serving base station may transmit to the terminal a conditional handover instruction based on the request approval received from the first target base station or the second target base station (S1060). The conditional handover instruction may include a handover command message and may be transmitted as an RRC connection reconfiguration message.

The terminal may measure, based on the conditional handover instruction received from the serving base station, each of the cells of the first TN operator and the second TN operator, for example, signal reception strength. The terminal may determine whether a handover condition is satisfied based on a measurement result (S1070). For example, the terminal may determine satisfaction of the handover condition when signal reception strength of the cell of the first TN operator is relatively greater than signal reception strength of the cell of the second TN operator.

The terminal may perform a handover from the serving base station to the first target base station based on a determination result of satisfaction of the handover condition (S1080). The terminal may release a connection with the serving base station and may perform a synchronization procedure and a random access procedure with the first target base station. The terminal may complete the handover through random access with the first target base station. The terminal may transmit to the first target base station an RRC reconfiguration complete message (S1090).

As described above, according to the present disclosure, the terminal may perform measurement for corresponding cell coverage when the terminal exists in cell coverage of a registered TN operator among coverages of a plurality of TN operators of TN cells overlapping with an NTN cell. Accordingly, the terminal can omit unnecessary measurement for cell coverage of other TN operators and can prevent an increase in power consumption. In addition, the terminal can perform cell reselection or handover from the NTN cell to a TN cell based on a measurement result and can improve efficiency of terminal mobility support.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving, from a satellite, cell information of a terrestrial network operator with which the terminal is registered;
determining whether the terminal exists within a cell of the terrestrial network operator based on the cell information; and
measuring the cell of the terrestrial network operator based on that the terminal exists within the cell of the terrestrial network operator.

2. The method of claim 1, wherein the cell information includes cell coverage information of the terrestrial network operator, and the determining of whether the terminal exists within the cell of the terrestrial network operator comprises:
acquiring a current location of the terminal; and
determining whether the current location of the terminal is included in the cell of the terrestrial network operator based on a reference location and a radius distance of the cell coverage information.

3. The method of claim 1, wherein the cell information includes cell frequency information of the terrestrial network operator, and the measuring of the cell of the terrestrial network operator comprises: measuring the cell of the terrestrial network operator based on the cell frequency information.

4. The method of claim 1, further comprising: periodically repeating an operation of determining whether the terminal exists within the cell of the terrestrial network operator based on that the terminal does not exist within the cell of the terrestrial network operator.

5. The method of claim 1, further comprising:
determining whether a cell reselection condition is satisfied based on a measurement result for the cell of the terrestrial network operator; and
camping on the cell of the terrestrial network operator based on that the cell reselection condition is satisfied.

6. The method of claim 5, wherein the determining of whether the cell reselection condition is satisfied comprises:
measuring a signal reception strength of each of a non-terrestrial network cell and the cell of the terrestrial network operator; and
determining satisfaction of the cell reselection condition based on that the signal reception strength of the cell of the terrestrial network operator is greater than the signal reception strength of the non-terrestrial network cell.

7. The method of claim 5, wherein the determining of whether the cell reselection condition is satisfied comprises:
comparing frequency priorities of the non-terrestrial network cell and the cell of the terrestrial network operator; and
determining satisfaction of the cell reselection condition based on that the frequency priority of the cell of the terrestrial network operator is higher than the frequency priority of the non-terrestrial network cell.

8. The method of claim 1, further comprising:
receiving, from the satellite, a measurement configuration message;
reporting, to the satellite, a measurement result for the cell of the terrestrial network operator based on the measurement configuration message;
receiving, from the satellite, a handover instruction determined based on the measurement result; and
performing a handover from the satellite to a base station of the terrestrial network operator based on the handover instruction.

9. The method of claim 8, further comprising:
measuring a cell of another terrestrial network operator overlapping with the cell of the terrestrial network operator based on the measurement configuration message;
reporting, to the satellite, measurement results for the cell of the terrestrial network operator and the cell of another terrestrial network operator;
determining whether a handover condition is satisfied based on the handover instruction received from the satellite; and
performing a handover from the satellite to a base station of one of the terrestrial network operator and the another terrestrial network operator based on satisfaction of the handover condition and based on the handover instruction.

10. The method of claim 9, wherein the determining of whether the handover condition is satisfied comprises:
measuring a signal reception strength of each of the cell of the terrestrial network operator and the cell of another terrestrial network operator cell; and
determining satisfaction of the handover condition based on that the signal reception strength of the cell of the terrestrial network operator is greater than the signal reception strength of the another terrestrial network operator cell.

11. A terminal comprising at least one processor, wherein the at least one processor causes the terminal to perform:
receiving, from a satellite, cell information of a terrestrial network operator with which the terminal is registered;
determining whether the terminal exists within a cell of the terrestrial network operator based on the cell information; and
measuring the cell of the terrestrial network operator based on that the terminal exists within the cell of the terrestrial network operator.

12. The terminal of claim 11, wherein the cell information includes cell coverage information of the terrestrial network operator, and in the determining of whether the terminal exists within the cell of the terrestrial network operator, the at least one processor causes the terminal to perform:
acquiring a current location of the terminal; and
determining whether the current location of the terminal is included in the cell of the terrestrial network operator based on a reference location and a radius distance of the cell coverage information.

13. The terminal of claim 11, wherein the cell information includes cell frequency information of the terrestrial network operator, and in the measuring of the cell of the terrestrial network operator, the at least one processor causes the terminal to perform: measuring the cell of the terrestrial network operator based on the cell frequency information.

14. The terminal of claim 11, wherein the at least one processor further causes the terminal to perform: periodically repeating an operation of determining whether the terminal exists within the cell of the terrestrial network operator based on that the terminal does not exist within the cell of the terrestrial network operator.

15. The terminal of claim 11, wherein the at least one processor further causes the terminal to perform:
determining whether a cell reselection condition is satisfied based on a measurement result for the cell of the terrestrial network operator; and
camping on the cell of the terrestrial network operator based on that the cell reselection condition is satisfied.

16. The terminal of claim 15, wherein in the determining of whether the cell reselection condition is satisfied, the at least one processor causes the terminal to perform:
measuring a signal reception strength of each of a non-terrestrial network cell and the cell of the terrestrial network operator; and
determining satisfaction of the cell reselection condition based on that the signal reception strength of the cell of the terrestrial network operator is greater than the signal reception strength of the non-terrestrial network cell.

17. The terminal of claim 15, wherein in the determining of whether the cell reselection condition is satisfied, the at least one processor causes the terminal to perform:
measuring a signal reception strength of each of a non-terrestrial network cell and the cell of the terrestrial network operator; and
determining satisfaction of the cell reselection condition based on that the signal reception strength of the cell of the terrestrial network operator is greater than the signal reception strength of the non-terrestrial network cell.

18. The terminal of claim 11, wherein the at least one processor further causes the terminal to perform:
receiving, from the satellite, a measurement configuration message;
reporting, to the satellite, a measurement result for the cell of the terrestrial network operator based on the measurement configuration message;
receiving, from the satellite, a handover instruction determined based on the measurement result; and
performing a handover from the satellite to a base station of the terrestrial network operator based on the handover instruction.

19. The terminal of claim 18, wherein the at least one processor further causes the terminal to perform:
measuring a cell of another terrestrial network operator overlapping with the cell of the terrestrial network operator based on the measurement configuration message;
reporting, to the satellite, measurement results for the cell of the terrestrial network operator and the cell of another terrestrial network operator;
determining whether a handover condition is satisfied based on the handover instruction received from the satellite; and
performing a handover from the satellite to a base station of one of the terrestrial network operator and the another terrestrial network operator based on satisfaction of the handover condition and based on the handover instruction.

20. The terminal of claim 19, wherein in the determining of whether the handover condition is satisfied, the at least one processor causes the terminal to perform:
measuring a signal reception strength of each of the cell of the terrestrial network operator and the cell of another terrestrial network operator cell; and
determining satisfaction of the handover condition based on that the signal reception strength of the cell of the terrestrial network operator is greater than the signal reception strength of the another terrestrial network operator cell.
